(19) United States
(12) Patent Application Publication
(10) Pub. No.: US 2023/0034111 A1
(43) Pub. Date: Feb. 2, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventor: Takahiro ISHIHARA, Machida-shi (JP)

(73) Assignee: TOYOTA JIDOSHA KABUSHIKI KAISHA, Toyota-shi (JP)

(21) Appl. No.: 17/743,633

(22) Filed: May 13, 2022

(30) Foreign Application Priority Data
Jul. 28, 2021 (JP) 2021-123708

(51) Int. Cl. G06Q 30/06

(52) U.S. Cl. CPC G06Q 30/0635; G06Q 30/0605; G06Q 30/0609

(57) ABSTRACT

An information processing device according to the present disclosure acquires first information relating to a specific commodity having a possibility of being purchased by a user. In addition, the information processing device acquires second information relating to a position of the user. Moreover, the information processing device allocates a specific vehicle on which the specific commodity is loaded to the user based on the first information and the second information.

### CROSS-REFERENCE TO RELATED APPLICATION

This application claims priority to Japanese Patent Application No. 2021-123708 filed on Jul. 28, 2021, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2020-184149 (JP 2020-184149 A) discloses an information processing device that manages traveling of a mobile-shop vehicle that sells a commodity to a user and is able to travel autonomously. The information processing device disclosed in JP 2020-184149 A decides a replenishment commodity that is a commodity with which the mobile-shop vehicle is to be replenished based on a sales condition of each of a plurality of types of commodities when the commodities are sold by the mobile-shop vehicle in a predetermined sales territory. Moreover, the information processing device generates a traveling plan for the mobile-shop vehicle based on purchase location information on a purchase location in which the replenishment commodity can be purchased and that includes at least position information of the purchase location.

### SUMMARY

The present disclosure is to provide a technique of promoting purchasing of a commodity by a user.

A first aspect of the present disclosure relates to an information processing device including a controller. The controller is configured to execute acquiring first information relating to a specific commodity having a possibility of being purchased by a user. The controller is configured to execute acquiring second information relating to a position of the user. The controller is configured to execute allocating a specific vehicle on which the specific commodity is loaded to the user based on the first information and the second information.

A second aspect of the present disclosure relates to an information processing method to be executed by a computer. The information processing method includes acquiring first information relating to a specific commodity having a possibility of being purchased by a user, acquiring second information relating to a position of the user, and allocating a specific vehicle on which the specific commodity is loaded to the user based on the first information and the second information.

A third aspect of the present disclosure relates to a storage medium storing a program causing a computer to execute an information processing method. The information processing method includes acquiring first information relating to a specific commodity having a possibility of being purchased by a user, acquiring second information relating to a position of the user, and allocating a specific vehicle on which the specific commodity is loaded to the user based on the first information and the second information.

With the present disclosure, it is possible to promote purchasing of the commodity by the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a sales system according to a first embodiment;

FIG. 2 is a block diagram schematically showing an example of a functional configuration of a management server;

FIG. 3 is a diagram showing a table configuration of commodity information stored in a commodity information database;

FIG. 4 is a diagram showing an example of a table configuration of schedule information stored in a schedule information database;

FIG. 5 is a flowchart of a vehicle allocation process;

FIG. 6 is a diagram showing a schematic configuration of a sales system according to a second embodiment.

### DETAILED DESCRIPTION OF EMBODIMENTS

An information processing device according to a first aspect of the present disclosure is a device that manages the allocation of a vehicle for selling a commodity to a user. A controller in the information processing device according to the first aspect of the present disclosure acquires first information. Here, the first information is information relating to a specific commodity having a possibility of being purchased by the user. In addition, the controller in the information processing device acquires second information. Here, the second information is information relating to a position of the user. By acquiring the first information and the second information, the controller can grasp the position of the user who has a possibility of purchasing the specific commodity. Therefore, the controller allocates a specific vehicle to the user based on the first information and the second information. Here, the specific vehicle is a vehicle on which the specific commodity is loaded.

As described above, the information processing device can allocate the specific vehicle on which the specific commodity is loaded to the user. As a result, the user is urged to purchase the specific commodity having a high possibility of being purchased by the user from the specific vehicle. In this way, it is possible to promote purchasing of the commodity by the user.

Hereinafter, specific embodiments of the present disclosure will be described based on the drawings. Unless otherwise specified, the dimensions, materials, shapes, relative arrangements, and the like of the components described in the present embodiment are not intended to limit the technical scope of the present disclosure solely thereto.

### First Embodiment

Overview of System

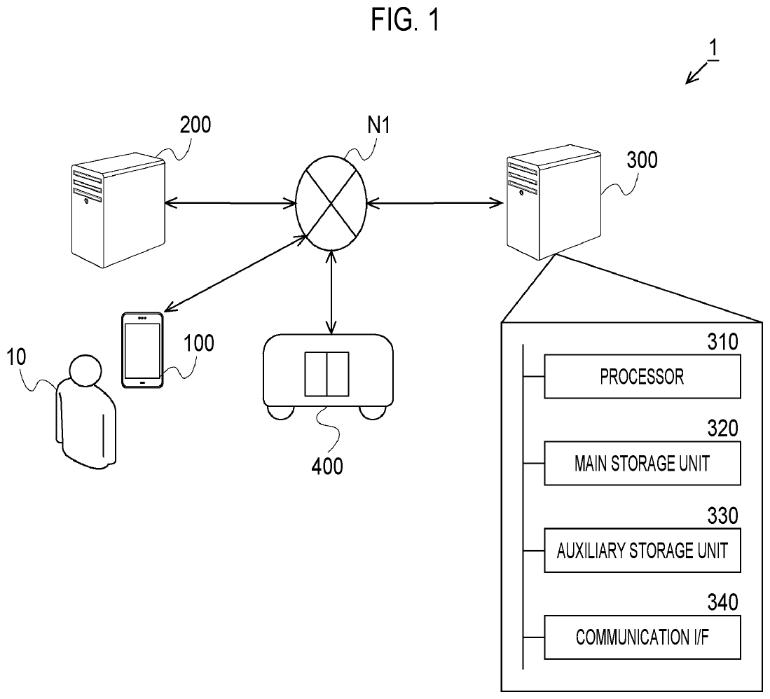

A sales system 1 in the present embodiment will be described based on FIG. 1. FIG. 1 is a diagram showing a schematic configuration of the sales system 1 according to the present embodiment. The sales system 1 includes a user terminal 100, an EC server 200, a management server 300, and a sales vehicle 400. In the sales system 1, the user terminal 100, the EC server 200, the management server 300, and the sales vehicle 400 are connected to each other by a network N1. As the network N1, a wide area network (WAN) that is a worldwide public communication network, such as the Internet, or telephone communication networks, such as a portable phone, may be employed.

User Terminal

The user terminal 100 is a terminal relating to a user 10. The user terminal 100 is, for example, a portable information terminal used by the user 10. The user 10 purchases the commodity sold on an EC site by using the user terminal 100. In this case, the user 10 may consider whether to purchase a certain commodity among a plurality of commodities sold on the EC site. In this case, the user 10 uses the user terminal 100 to give a tag indicating that the user 10 considers purchasing to the commodity (hereinafter, may be referred to as “specific commodity”) for which the user 10 considers purchasing on the EC site. The user terminal 100 transmits tag information indicating that the specific commodity is tagged to the EC server 200 via the network N1. In addition, the user terminal 100 transmits schedule information relating to a schedule of the user 10 to the management server 300 via the network N1. Here, the schedule information is information including a future position of the user 10. In addition, the user 10 uses the user terminal 100 to register a position of an office of the user 10. The user terminal 100 transmits information relating to the position of the office of the user 10 to the management server 300.

EC Server

The EC server 200 is a server for operating the electronic commerce (EC) site. The EC server 200 sells various commodities on the EC site. The EC server 200 receives the tag information from the user terminal 100 via the network N1. As a result, the EC server 200 can grasp the specific commodity. Therefore, the EC server 200 generates the information relating to the specific commodity (hereinafter, may be referred to as “commodity information”) and stores the generated information in a non-transitory storage medium.

Note that, in the present embodiment, the EC server 200 generates the commodity information by receiving the tag information from the user terminal 100. However, the EC server 200 does not always have to generate the commodity information by receiving the tag information from the user terminal 100. A known method can be adopted as a method in which the EC server 200 generates the commodity information. The EC server 200 may generate the commodity information based on, for example, a time when the user terminal 100 continues to display a commodity page on the EC site. In this case, the EC server 200 specifies, for example, a commodity for which the user terminal 100 continues to display the commodity page for a predetermined time or longer as the specific commodity to generate the commodity information. In addition, the EC server 200 may generate the commodity information, for example, by acquiring information relating to the commodity that is not purchased while being registered in a favorite list. In addition, the EC server 200 may generate the commodity information, for example, by acquiring information relating to the commodity that is not purchased in a state of being input in a purchase cart.

Sales Vehicle

The sales vehicle 400 is a vehicle on which various commodities including the specific commodity are loaded. The sales vehicle 400 sells the loaded commodities by moving to a location at which a customer is present. The sales vehicle 400 may be an autonomous driving vehicle or a vehicle driven by a driver.

Management Server

The management server 300 is a device that manages the allocation of the sales vehicle 400. The management server 300 receives the information relating to the position of the office of the user 10 from the user terminal 100. As a result, the management server 300 can grasp the position of the office of the user 10. In addition, the management server 300 receives the commodity information from the EC server 200. In addition, the management server 300 receives the schedule information of the user 10 from the user terminal 100. Moreover, the management server 300 allocates the sales vehicle 400 to the user 10 based on the commodity information and the schedule information. The details of the method in which the management server 300 allocates the sales vehicle 400 to the user 10 will be described below.

The management server 300 is configured to include a computer having a processor 310, a main storage unit 320, an auxiliary storage unit 330, and a communication interface (communication I/F) 340. The processor 310 is, for example, a central processing unit (CPU) or a digital signal processor (DSP). The main storage unit 320 is, for example, a random access memory (RAM). The auxiliary storage unit 330 is, for example, a read only memory (ROM). In addition, the auxiliary storage unit 330 is, for example, a hard disk drive (HDD) or a disk recording medium, such as a CD-ROM, a DVD disk, or a Blu-ray disk. In addition, the auxiliary storage unit 330 may be a removable medium (portable storage medium). Here, examples of the removable medium include a USB memory or an SD card. The communication I/F 340 is, for example, a local area network (LAN) interface board or a wireless communication circuit for wireless communication.

In the management server 300, an operating system (OS), various programs, various information tables, and the like are stored in the auxiliary storage unit 330. In addition, in the management server 300, the processor 310 can realize various functions as described below by loading the programs stored in the auxiliary storage unit 330 into the main storage unit 320 and executing the programs. Note that a part or all of the functions in the management server 300 may be realized by a hardware circuit, such as an ASIC or an FPGA. Note that the management server 300 does not always have to be realized by a single physical configuration, and may be configured by a plurality of the computers linked to each other.

Functional Configuration

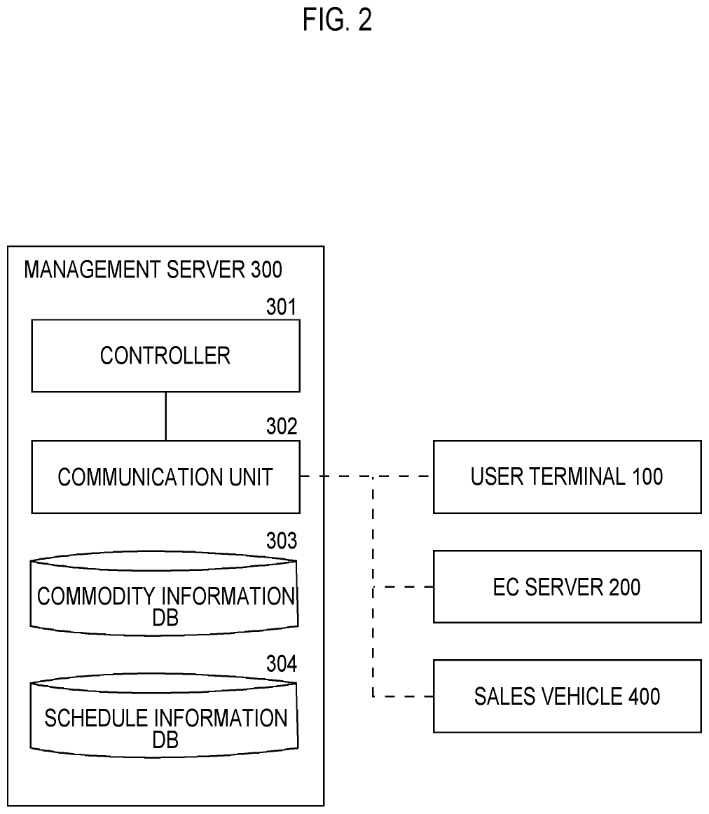

Next, a functional configuration of the management server 300 constituting the sales system 1 according to the present embodiment will be described based on FIGS. 2 to 4. FIG. 2 is a block diagram schematically showing an example of the functional configuration of the management server 300.

The management server 300 includes a controller 301, a communication unit 302, a commodity information database 303 (commodity information DB 303), and a user information database 304 (schedule information DB 304). The controller 301 has a function of executing arithmetic processing for controlling the management server 300. The controller 301 can be realized by the processor 310 in the management server 300. The communication unit 302 has a function of connecting the management server 300 to the network N1. The communication unit 302 can be realized by the communication I/F 340 in the management server 300.

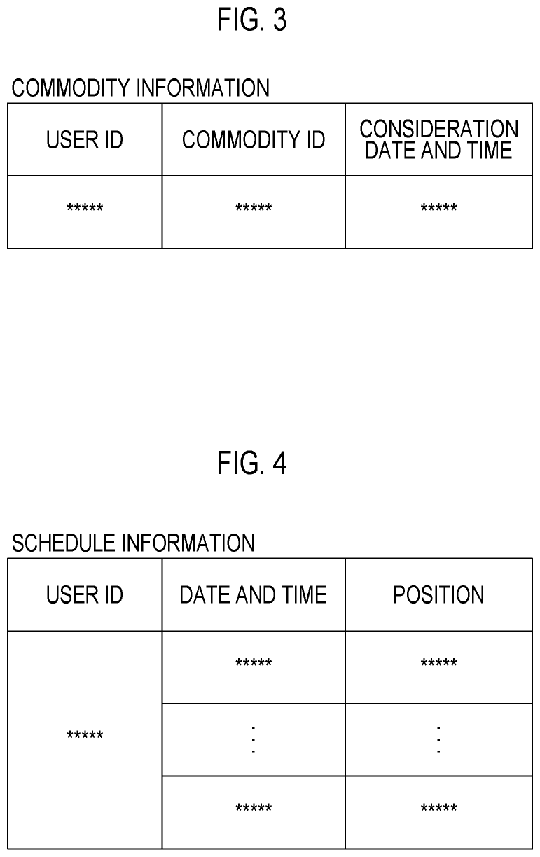

The controller 301 receives the commodity information from the EC server 200 via the communication unit 302. The controller 301 stores the received commodity information in the commodity information DB 303. FIG. 3 is a diagram showing a table configuration of the commodity information stored in the commodity information DB 303. As shown in FIG. 3, the commodity information includes a user ID field, a commodity ID field, and a consideration date-and-time field. An identifier (user ID) for specifying the user 10 is input to the user ID field. An identifier (commodity ID) for specifying the specific commodity is input to the commodity ID field. The date and time when the user 10 considers purchasing of the specific commodity is input to the consideration date-and-time field. That is, the date and time when the user 10 uses the user terminal 100 to give the tag to the specific commodity is input to the consideration date-and-time field.

The controller 301 receives the schedule information from the user terminal 100 by the communication unit 302. The controller 301 stores the received schedule information in the schedule information DB 304. FIG. 4 is a diagram showing an example of a table configuration of the schedule information stored in the schedule information DB 304. As shown in FIG. 4, the schedule information includes a user ID field, a date-and-time field, and a position field. The user ID of the user 10 is input to the user ID field. The date and time when the user 10 has a schedule is input to the date-and-time field. A position at which the user 10 is scheduled to be present at the date and time input to the date-and-time field is input to the position field. For example, the date and time when the user 10 is present at the office and the position of the office of the user 10 are input to the date-and-time field and the position field to correspond to each other. In addition, for example, the date and time when the user 10 is present at home and a home position of the user 10 are input to the date-and-time field and the position field to correspond to each other. The controller 301 acquires the commodity information from the commodity information DB 303. As a result, the controller 301 can grasp the specific commodity for which the user 10 considers purchasing.

Here, in a case where the user 10 is present at the office, it is assumed that the user 10 works. Therefore, even in a case where the sales vehicle 400 is allocated in the vicinity of the office of the user 10 when the user 10 is present at the office, it is assumed that the user 10 has a low possibility of purchasing the specific commodity. Therefore, the controller 301 acquires the schedule information from the schedule information DB 304. As a result, the controller 301 can grasp the position at which the user 10 is present at specific date and time. Therefore, in a case where the user 10 is present at the office of the user 10 when the sales vehicle 400 is allocated, the controller 301 does not allocate the sales vehicle 400 to the user 10. Note that the office of the user 10 in the present embodiment corresponds to a “predetermined location” according to the present disclosure.

Vehicle Allocation Process

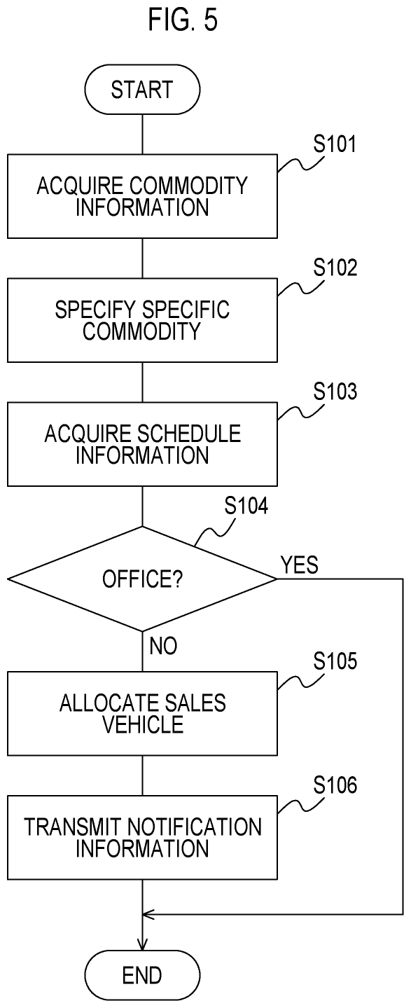

Next, in the sales system 1 according to the present embodiment, a vehicle allocation process executed by the controller 301 in the management server 300 will be described based on FIG. 5. FIG. 5 is a flowchart of the vehicle allocation process. The vehicle allocation process is a process for allocating the sales vehicle 400 to the user 10. Execution of the vehicle allocation process is started at a predetermined timing. The predetermined timing is, for example, a timing at which a manager of the management server 300 allocates the sales vehicle 400 and tries to sell the specific commodity to the user 10.

In the vehicle allocation process, first, in S101, the commodity information is acquired from the commodity information DB 303. Next, in S102, the specific commodity is specified from the commodity ID included in the commodity information. In addition, in S103, the schedule information is acquired from the schedule information DB 304. Next, in S104, a determination is made as to whether the user 10 is present at the office at the date and time when the sales vehicle 400 is expected to arrive based on the schedule information. In a case where a positive determination is made in S104, a low possibility that the user 10 purchases the specific commodity is expected. Therefore, in a case where a positive determination is made in S104, the vehicle allocation process is terminated.

In a case where a negative determination is made in S104, a higher possibility that the user 10 purchases the specific commodity than a case where a positive determination is made is expected. Therefore, in S105, the sales vehicle 400 is allocated to the user 10. In S106, notification information indicating that the sales vehicle 400 on which the specific commodity is loaded is allocated to the user 10 is transmitted to the user terminal 100. As a result, the user 10 can grasp that the sales vehicle 400 on which the specific commodity is loaded is allocated to the user 10. Moreover, the vehicle allocation process is terminated. Note that the notification information in the present embodiment corresponds to “information relating to the allocation of the specific vehicle” according to the present disclosure.

As described above, the sales system 1 allocates the sales vehicle 400 on which the specific commodity for which the user 10 considers purchasing on the EC site is loaded to the user 10. As a result, the user 10 can reconsider purchasing of the specific commodity for which purchasing is considered once. Here, since the user 10 considers purchasing of the specific commodity on the EC site, the user 10 does not consider purchasing while actually looking at the specific commodity. However, since the sales vehicle 400 on which the specific commodity is loaded is allocated to the user 10 by the sales system 1, the user 10 can actually look at the specific commodity and reconsider purchasing. In addition, in a case where the user 10 is present at a location at which the possibility that the user 10 purchases the specific commodity is higher, the sales vehicle 400 is allocated to the user 10. In this way, it is possible to promote purchasing of the specific commodity by the user 10. As a result, it is possible to promote purchasing of the commodity sold on the EC site.

### Modification Example 1

In the present embodiment, the management server 300 allocates the sales vehicle 400 by using the schedule information of the user 10. However, the management server 300 does not always have to allocate the sales vehicle 400 by using the schedule information of the user 10. The management server 300 may allocate the sales vehicle 400 based on a current position of the user 10, for example. Specifically, in a case where the vehicle allocation process is executed, the management server 300 acquires the current position of the user 10 instead of the schedule information. Moreover, in a case where a determination is made that the user 10 is currently present at a location other than the office, the management server 300 allocates the sales vehicle 400 to the current position of the user 10. That is, the management server 300 does not allocate the specific vehicle at the timing when a determination is made that the user 10 is currently present at the office. Even in this way, it is possible to promote purchasing of the specific commodity by the user 10.

### Modification Example 2

In the present embodiment, the management server 300 receives the commodity information that is the information relating to the commodity for which the user 10 considers purchasing from the EC server 200. As a result, the management server 300 grasps the commodity (specific commodity) having a possibility of being purchased by the user 10. However, the management server 300 does not always have to grasp the commodity having a possibility of being purchased by the user 10 by receiving the commodity information from the EC server 200. The management server 300 may grasp the commodity having a possibility of being purchased by the user 10 by receiving information relating to a purchase history of the user 10 from the EC server 200, for example. Specifically, the management server 300 acquires the information relating to the purchase history of the user 10 instead of the commodity information in the vehicle allocation process. The management server 300 specifies the commodity purchased by the user 10 at a predetermined frequency as the commodity (specific commodity) having a possibility of being purchased by the user 10. Moreover, the management server 300 allocates the sales vehicle 400 to the user 10 in a case where the user 10 is present outside the office.

In addition to the purchase history of the user 10, the management server 300 may specify the specific commodity based on, for example, a preference of the user 10. In this case, the management server 300 receives information relating to the preference of the user 10 from the EC server 200. Moreover, the management server 300 specifies the commodity that suits the preference of the user 10 as the commodity (specific commodity) having a possibility of being purchased by user 10.

### Modification Example 3

In the present embodiment, the management server 300 transmits the notification information relating to the vehicle allocation of the sales vehicle 400 to the user terminal 100 in a case where the sales vehicle 400 is allocated to the user 10 in the vehicle allocation process. However, the management server 300 may transmit inquiry information to the user terminal 100 before the sales vehicle 400 is allocated to the user 10. Here, the inquiry information is information for inquiring whether the user 10 requests the allocation of the sales vehicle 400 on which the specific commodity is loaded to the user 10.

In this case, in a case where the user terminal 100 receives the inquiry information relating to the allocation of the sales vehicle 400, the user terminal 100 displays a screen indicating whether the user 10 requests the allocation of the sales vehicle 400. In a case where the user 10 requests the allocation of the sales vehicle 400 to purchase the specific commodity or reconsider purchasing, the user terminal 100 uses the user terminal 100 to transmit request information for requesting the allocation of the sales vehicle 400. In a case where the management server 300 receives the request information from the user terminal 100, the management server 300 allocates the sales vehicle 400 to the user 10.

As a result, it is possible to allocate the sales vehicle 400 to the user 10 in a case where the user 10 requests the allocation of the sales vehicle 400. As a result, it is possible to allocate the sales vehicle 400 to the user 10 who has a higher possibility of purchasing the specific commodity as compared with the allocation of the sales vehicle 400 without receiving the request information. Note that the inquiry information in the present embodiment corresponds to the “information relating to the allocation of the specific vehicle” according to the present disclosure.

### Modification Example 4

In the present embodiment, the management server 300 does not allocate the sales vehicle 400 in a case where the user 10 is present at the office. However, the location at which the management server 300 does not allocate the sales vehicle 400 to the user 10 is not always limited to the office of the user 10. The location at which the management server 300 does not allocate the sales vehicle 400 to the user 10 may be a school of the user 10. In addition, the predetermined location may be a location registered by the user 10 as a location at which the commodity is not purchased even in a case where the sales vehicle 400 is allocated to the user 10. Note that, in the present embodiment, the office of the user 10 is assumed to be the location having a low possibility that the user 10 purchases the specific commodity. However, the management server 300 may allocate the sales vehicle 400 in a case where the user 10 is present at the office.

### Modification Example 5

In the present modification example, the management server 300 is a device that manages the allocation of a plurality of sales vehicles 400. In this case, the management server 300 has vehicle information in which each sales vehicle 400 and the commodity loaded on each sales vehicle 400 are associated with each other. The management server 300 decides the sales vehicle 400 on which the specific commodity is loaded among the sales vehicles 400 as the vehicle to be allocated, and allocates the decided sales vehicle 400 to the user 10 based on the vehicle information. In addition, in a case where there are the sales vehicles 400 on which the specific commodity is loaded among the sales vehicles 400, the management server 300 decides the sales vehicle 400 closest to a vehicle allocation destination of the specific commodity to the user 10 as the sales vehicle 400 to be allocated to the user.

### Second Embodiment

In the first embodiment, the specific commodity is the commodity for which the user 10 considers purchasing on the EC site. On the other hand, in the present embodiment, the specific commodity is the commodity for which the user 10 considers purchasing at the shop. Hereinafter, solely the points different from the first embodiment will be described.

Overview of System

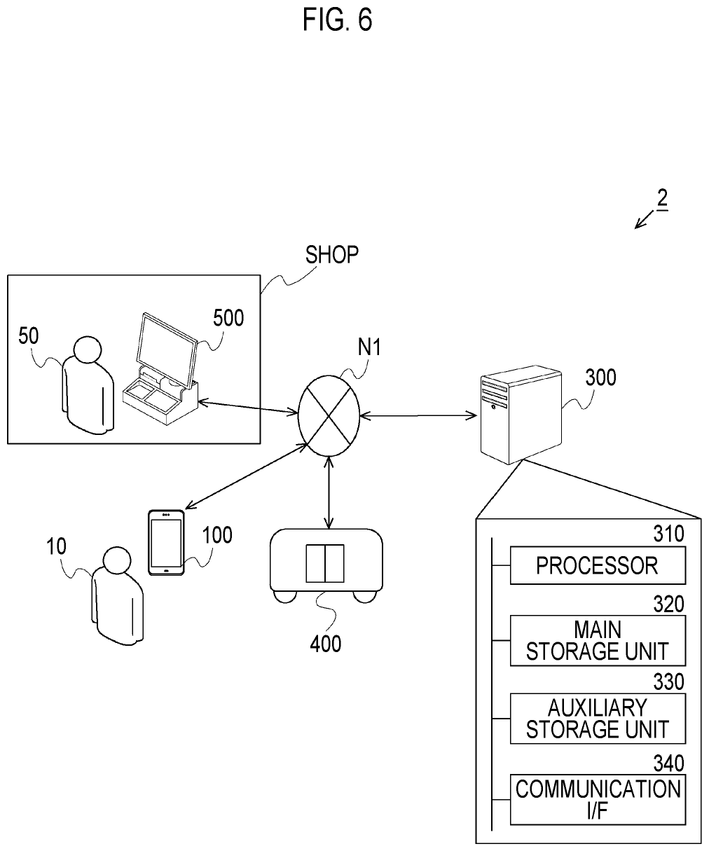

A sales system 2 in the present embodiment will be described based on FIG. 6. FIG. 6 is a diagram showing a schematic configuration of the sales system 2 according to the present embodiment. The sales system 2 includes the user terminal 100, the management server 300, the sales vehicle 400, and an employee terminal 500. In the sales system 2, the user terminal 100, the management server 300, the sales vehicle 400, and the employee terminal 500 are connected to each other by the network N1.

Employee Terminal

The employee terminal 500 is a terminal in the shop. The employee terminal 500 is, for example, a point of sale (POS) register in the shop. The employee terminal 500 is used by an employee 50. Here, the employee 50 is an employee in charge of the customer service in the shop. The employee 50 is in charge of the customer service to the user 10 in a case where the user 10 visits the shop. By performing the customer service to the user 10, the employee 50 can grasp the commodity for which the user 10 considers purchasing. A known method can be adopted as a method in which the employee 50 in the shop specifies the user 10. For example, the employee 50 specifies the user 10 by communicating with the user terminal 100 by a device that is provided in the shop and identifies a visitor to the shop, and acquiring the user ID for specifying the user 10. Therefore, the employee 50 inputs the information relating to the commodity for which the user 10 considers purchasing to the employee terminal 500. The employee terminal 500 generates the commodity information based on the information relating to the commodity for which the user 10 considers purchasing that is input by the employee 50, and transmits the commodity information to the management server 300.

The management server 300 receives the commodity information from the employee terminal 500. The management server 300 stores the received commodity information in the commodity information DB 303. Moreover, the management server 300 allocates the sales vehicle 400 based on the commodity information stored in the commodity information DB 303 and the schedule information of the user 10. Even in this way, it is possible to promote purchasing of the specific commodity by the user 10. As a result, it is possible to promote purchasing of the commodity sold in the shop.

### Modification Example

In the present embodiment, the management server 300 allocates the sales vehicle 400 based on the commodity information received from the employee terminal 500. However, the management server 300 does not always have to allocate the sales vehicle 400 based on the commodity information received from the employee terminal 500. The management server 300 receives, for example, a moving image obtained by imaging the inside of the shop by a camera in the shop. The moving image received by the management server 300 may include a behavior taken by the user 10 in the shop.

The management server 300 specifies the user 10 based on the received moving image. In addition, the management server 300 detects whether the user 10 considers purchasing of the commodity based on the received moving image. The management server 300 detects that the user 10 considers purchasing of the commodity, for example, in a case where the user 10 looks at the commodity for a predetermined time or longer. In a case where the management server 300 detects that the user 10 considers purchasing of the commodity, the management server 300 records the commodity ID of the commodity for which the user 10 considers purchasing in the commodity information in the commodity information DB 303. Moreover, the management server 300 allocates the sales vehicle 400 based on the commodity information in the commodity information DB 303 and the schedule information of the user 10. Even in this way, it is possible to promote purchasing of the specific commodity by the user 10.

### Third Embodiment

In the present embodiment, it is assumed that a plurality of users 10 is present. Hereinafter, solely the points different from the first embodiment will be described.

The management server 300 receives the commodity information relating to the commodity that each user 10 considers purchasing on the EC site from the user terminal 100 used by each user 10. The management server 300 stores the commodity information relating to each user 10 received from each user terminal 100 in the commodity information DB 303. Here, the specific commodity indicated by the commodity information relating to each user 10 may be different for each user 10. In addition, the management server 300 receives the schedule information of each user 10 from each user terminal 100. The management server 300 stores the schedule information of each user 10 received from each user terminal 100 in the schedule information DB 304.

In the vehicle allocation process, in a case where each user 10 is not present at the office of each user 10, the management server 300 allocates the specific vehicle on which the specific commodity for which each user 10 considers purchasing is loaded to each user 10. In this case, the management server 300 allocates the sales vehicle 400 based on a priority of each user 10. Specifically, the management server 300 sets the priority of each user 10 in an order in which the consideration date and time in the commodity information relating to each user 10 is newer. Moreover, the management server 300 allocates the sales vehicle 400 such that a visit order of the sales vehicle 400 is earlier as the priority is higher.

Here, the user 10 whose consideration date and time is new has a short time after the user 10 considers purchasing of the specific commodity. Therefore, it is assumed that the user 10 whose consideration date and time is new is more interested in the specific commodity than the user 10 whose consideration date and time is older. In addition, by making the visit order first, in a case where the sales vehicle 400 arrives in the vicinity of the user 10, it is possible to suppress the movement of the user 10 from the location. Therefore, by making the visit order of the sales vehicle 400 to the user 10 who is more interested in the specific commodity first, it is possible to more reliably allocate the sales vehicle 400 to the user 10. As a result, it is possible to promote purchasing of the specific commodity by the user 10 who is more interested in the specific commodity.

### Modification Example 1

In the present embodiment, the priority is set in an order in which the consideration date and time in the commodity information relating to each user 10 is newer. However, the priority does not always have to be set in the order in which the consideration date and time in the commodity information relating to each user 10 is newer. The priority may be set based on, for example, the order in which the date and time after the user 10 considers purchasing of the specific commodity is older (order in which a consideration period of time of the specific commodity is longer). In this case, it is assumed that the user 10 who considers purchasing of the specific commodity for a long period of time is hesitant to purchase the specific commodity than the user 10 who considers purchasing of the specific commodity for a short period of time. Therefore, the management server 300 sets the priority of the user 10 who has a long period of time after the user 10 considers the purchase of the specific commodity to be higher than the priority of the user 10 who has a short period of time after the user 10 considers purchasing of the specific commodity. As a result, it is possible to more reliably allocate the sales vehicle 400 to the user 10 who is more hesitant to purchase the specific commodity. As a result, it is possible to promote purchasing of the specific commodity to the user 10 who is more hesitant to purchase the specific commodity.

### Modification Example 2

In the present embodiment, in a case where the users 10 are present, the management server 300 allocates the sales vehicle 400 based on the priority. On the other hand, in the modification example, the management server 300 allocates the sales vehicle 400 based on the position at which the users 10 are present. Specifically, the management server 300 may decide a centroid (or point in the vicinity of the centroid at which the sales vehicle 400 easily stops) at the position at which the users 10 present as the vehicle allocation destination of the sales vehicle 400. In addition, the management server 300 may decide a predetermined location at which the users 10 easily visit as the vehicle allocation destination of the sales vehicle 400, in addition to the centroid of the position at which the users 10 are present. As a result, the sales vehicle 400 is allocated to a point that is easily accessible to all of the users 10. As a result, it is possible to promote purchasing of the specific commodity to the users 10.

### Other Embodiments

The embodiments described above are merely examples, and the present disclosure can be implemented with appropriate modifications within a scope not departing from the gist of the present disclosure. In addition, the process and means described in the present disclosure can be freely combined and implemented as long as no technical inconsistency occurs.

In addition, the process executed by one device in the description may be allocated and executed by a plurality of devices. Alternatively, the process executed by different devices in the description may be executed by one device. In the computer system, the hardware configuration (server configuration) that realizes each function can be flexibly changed.

The present disclosure can also be realized by supplying a computer program that implements the functions described in the above embodiments to a computer, and reading and executing the program by one or more processors included in the computer. Such a computer program may be provided to the computer by a non-transitory computer-readable storage medium that can be connected to a system bus of the computer, or may be provided to the computer via a network. The non-transitory computer-readable storage medium includes, for example, any type of disk, such as a magnetic disk (floppy (registered trademark) disk, hard disk drive (HDD), or the like) or an optical disk (CD-ROM, DVD disk, Blu-ray disk, or the like), and any type of media suitable for storing an electronic command, such as a read only memory (ROM), a random access memory (RAM), an EPROM, an EEPROM, a magnetic card, a flash memory, or an optical card.

What is claimed is:

1. An information processing device comprising a controller configured to execute
acquiring first information relating to a specific commodity having a possibility of being purchased by a user,
acquiring second information relating to a position of the user, and
allocating a specific vehicle on which the specific commodity is loaded to the user based on the first information and the second information.

2. The information processing device according to claim 1, wherein the controller is configured not to allocate the specific vehicle at a timing when a determination is made that the user is present at a predetermined location based on the second information.

3. The information processing device according to claim 2, wherein the predetermined location is a location registered in advance as a location at which the user does not purchase a commodity.

4. The information processing device according to claim 3, wherein the predetermined location is an office or a school of the user.

5. The information processing device according to claim 1, wherein the second information is schedule information including a future position of the user.

6. The information processing device according to claim 1, wherein the specific vehicle is decided based on information in which a plurality of vehicles and commodities loaded on the vehicles are associated with each other.

7. The information processing device according to claim 1, wherein:
the specific commodity is a commodity for which the user considers purchasing on an EC site; and
the first information is information in which the specific commodity and the user are associated with each other.

8. The information processing device according to claim 7, wherein the controller is configured to acquire the first information from a server device that manages the EC site.

9. The information processing device according to claim 1, wherein the specific commodity is a commodity for which the user considers purchasing at a shop that sells the specific commodity.

10. The information processing device according to claim 9, wherein the controller is configured to acquire the first information from a terminal relating to an employee in the shop.

11. The information processing device according to claim 9, wherein the controller is configured to acquire the first information based on a moving image including the user imaged by a camera in the shop.

12. The information processing device according to claim 1, wherein the controller is configured to specify the specific commodity based on a purchase history of a commodity of the user.

13. The information processing device according to claim 1, wherein the controller is configured to specify the specific commodity based on a preference of the user.

14. The information processing device according to claim 7, wherein the controller is configured to, in a case where a plurality of the users is present, allocate the specific vehicle to the users based on a priority of allocating the specific vehicle to the users.

15. The information processing device according to claim 14, wherein the priority is decided based on date and time when each of the users considers purchasing of the specific commodity.

16. The information processing device according to claim 1, wherein the controller is configured to, in a case where a plurality of the users is present, decide one vehicle allocation destination for the users based on the second information relating to the users.

17. The information processing device according to claim 1, wherein the controller is configured to transmit information relating to allocation of the specific vehicle to a terminal relating to the user.

18. An information processing method to be executed by a computer, the information processing method comprising:
acquiring first information relating to a specific commodity having a possibility of being purchased by a user;
acquiring second information relating to a position of the user; and
allocating a specific vehicle on which the specific commodity is loaded to the user based on the first information and the second information.

19. The information processing method according to claim 18, wherein the specific vehicle is not allocated at a timing when a determination is made that the user is present at a predetermined location based on the second information.

20. A non-transitory storage medium storing a program causing a computer to execute an information processing method comprising:
acquiring first information relating to a specific commodity having a possibility of being purchased by a user;
acquiring second information relating to a position of the user; and
allocating a specific vehicle on which the specific commodity is loaded to the user based on the first information and the second information.
